(19) United States
(12) Patent Application Publication
(10) Pub. No.: US 2012/0261154 A1
(43) Pub. Date: Oct. 18, 2012

(54) STRUCTURE FOR ADJUSTING POSITIVE OR REVERSE ROTATION OF PNEUMATIC TOOL

(76) Inventor: LUNG-PAO CHEN, Zhubei City (TW)

(21) Appl. No.: 13/442,867

(22) Filed: Apr. 10, 2012

(30) Foreign Application Priority Data
Apr. 15, 2011 (TW) 100206655

(51) Int. Cl. B25F 5/00

(52) U.S. Cl. 173/221; 173/218

(57) ABSTRACT

A structure for adjusting positive or reverse rotation of a pneumatic tool is proposed to be mainly composed of an outer casing, a driving device and a knob. An air controlling part arranged on the outer casing leads air to be transmitted from an air incoming chamber in the outer casing to the driving device through a reducing air intake. A bearing seat is arranged in the driving device. The knob arranged on the outer casing extends with an annular wall for separating air incoming from air discharging. An armature slot formed at the annular wall connects to and communicates with the bearing seat. The annular wall has a protrusion formed with a first air intake allowed to communicate with a positive or reverse air intake. Thereby, the first air intake can adjusted to be aligned with the positive or reverse air intake by rotation of the knob.

### BACKGROUND OF THE DISCLOSURE

a) Field of the Disclosure

The invention relates to a pneumatic tool, and more particularly, to a structure for adjusting positive or reverse rotation of a pneumatic tool by a knob for relocating an air inlet and full separating air incoming from air discharging.

b) Brief Description of the Related Art

FIG. 1 is a schematic view of a structure for controlling rotation directions and rotation speeds of a conventional pneumatic tool published in R.O.C. utility-model patent No. 87217090, which is disclosed to be composed of an air cylinder 40, an air gate 50 and an adjusting part 60.

The air cylinder 40 has a pillar-shaped outer casing 41 with a suitable length, an air chamber 42 extending from a surface at a left end of a shaft of the outer casing 41 to the right, wherein two directional air holes 43 and 44 for positive and reverse rotations pass through a wall at a right end of the shaft of the outer casing 41 so as to connect the air chamber 42 to the outside at the right end of the outer casing 41, and an annular wall 45 coaxially extending from the right end of the shaft of the outer casing 41 to the right, wherein two lateral holes 46 pass through front and back walls of the annular wall 45, respectively, and a bottom hole 47 passes through a bottom wall of the annular wall 45.

The air gate 50 contains an annular body 51 having a suitable thickness and inner diameter, coaxially fitting in the annular wall 45 and having an end in an axial direction butting against a surface at a right end of the shaft of the outer casing 41 such that the directional air holes 43 and 44 are closed. Two air holes 52 extend from an end of a shaft of the annular body adjacent to the directional air holes 43 and 44 respectively inwards to an inner annular surface 511 of the annular body 51 with turns. Two air vents 53 are set at the annular body 51 and each have an axis vertical to an axis of the annular body 51, coaxially communicating with the corresponding lateral holes 46 at two sides of the outer casing 41 of the air cylinder 40. An air intake 54 passes through a bottom wall of the annular body 51 and has an axis vertical to the axis of the annular body 51, coaxially communicating with the bottom hole 47.

The adjusting part 60 contains a base 61, shaped like a round plate, having a suitable thickness and outer diameter and coaxially arranged in the annular body 51. The base 61 has an outer annular surface 611 against the inner annular surface 511 of the annular body 51 such that each hole at the inner annular surface 511 is closed and a suitable air tight is led therebetween. The base 61 can pivot between positions of reverse and positive rotations. An air path 62 axially passes through the outer annular surface 611 at top and bottom ends of the base 61. An air intake 63 and air vent 64 are arranged at the outer annular surface 611 at two sides of the air path 62. Two air discharging gaps 65 are arranged at two opposite front and back positions of the outer annular surface 611.

Accordingly, the above structure has the following drawbacks:

1. Parts are numerous and thus cost is increased.

2. Fitting of pairs of holes leads assembling to be troublesome and assignment to be difficult. The tool is caused to be broken.

3. Parts are numerous and thus volume is increased.

4. The structure is complicated and thus is not beneficial to be processed.

### SUMMARY OF THE DISCLOSURE

The invention has a main objective that air incoming is effectively separated from air discharging and positive or reverse rotation of a driving device is easily adjusted.

In order to achieve the above objectives, a structure for adjusting positive or reverse rotation of a pneumatic tool is proposed to be mainly composed of an outer casing, a driving device and a knob. An air controlling part arranged on the outer casing leads air to be transmitted from an air incoming chamber in the outer casing to the driving device through a reducing air intake. A bearing seat is arranged in the driving device. A cover is arranged at a side surface of the driving device and provided with a positive air intake and reverse air intake. The knob arranged on the outer casing extends with an annular wall for separating air incoming from air discharging An armature slot formed at the annular wall connects to and communicates with the bearing seat. The annular wall has a protrusion formed with a first air intake. When the protrusion butts against the cover, the first air intake communicates with the positive or reverse air intake by rotating the knob.

The invention has another objective that the whole structure for adjusting positive or reverse rotation is simplified and thus process cost can be reduced.

The invention has another objective that a rotation speed output from the pneumatic tool can be adjusted by the knob used for promptly adjusting air incoming.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a schematic view of a structure for controlling rotation directions and rotation speeds of a conventional pneumatic tool.

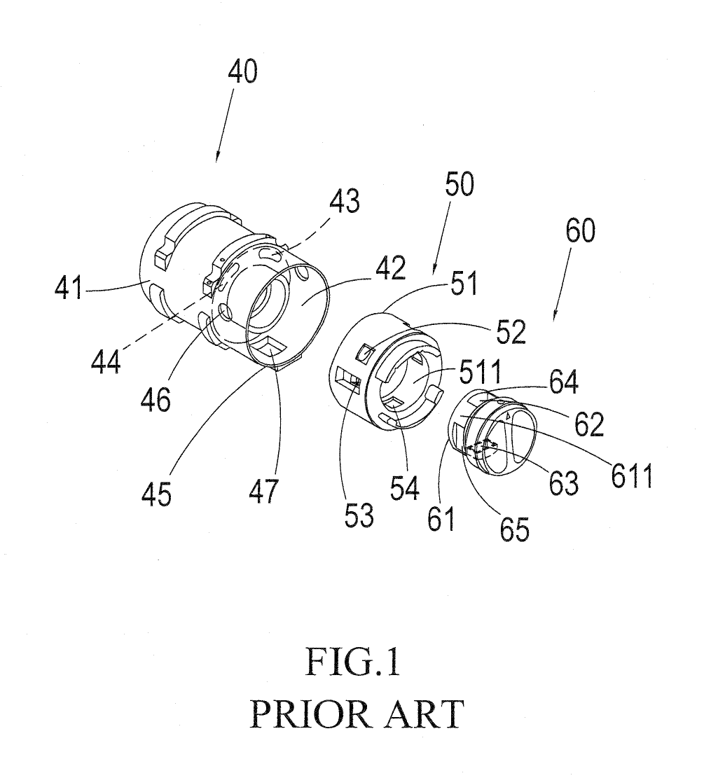

FIG. 2 is a cross-sectional view in accordance with an embodiment of the present invention.

FIG. 3 is a three-dimensional exploded view in accordance with an embodiment of the present invention.

FIG. 3A is an enlarged bottom perspective view of the knob.

FIG. 3B is an enlarged view of a portion of FIG. 3.

FIG. 4 is a schematic view of a condition of air incoming in accordance with the present invention.

FIG. 5 is a schematic view of a condition of a maximum air inflow adjusted by rotation of a knob in accordance with the present invention.

FIG. 5A is an enlarged schematic view of a condition of a maximum air inflow adjusted by rotation of a knob in accordance with the present invention.

FIG. 6 is a first schematic view of a condition of an air flow driving a driving device in accordance with the present invention.

FIG. 6A is a second schematic view of a condition of an air flow driving a driving device in accordance with the present invention.

FIG. 7 is a schematic view of a condition of a pneumatic device operating in reverse rotation in accordance with the present invention.

FIG. 8 is a schematic view of a condition of reducing an air outflow in accordance with the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

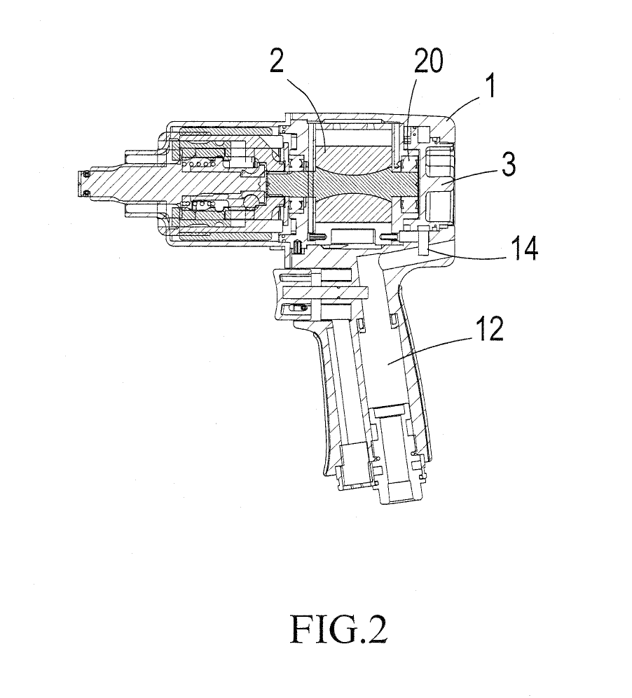

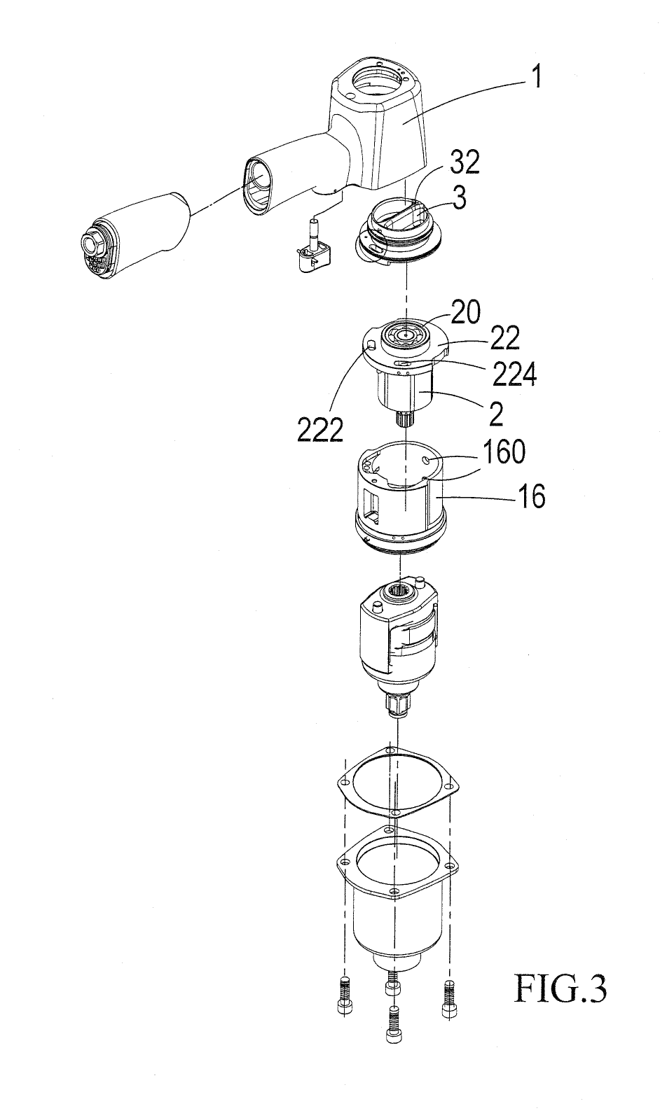

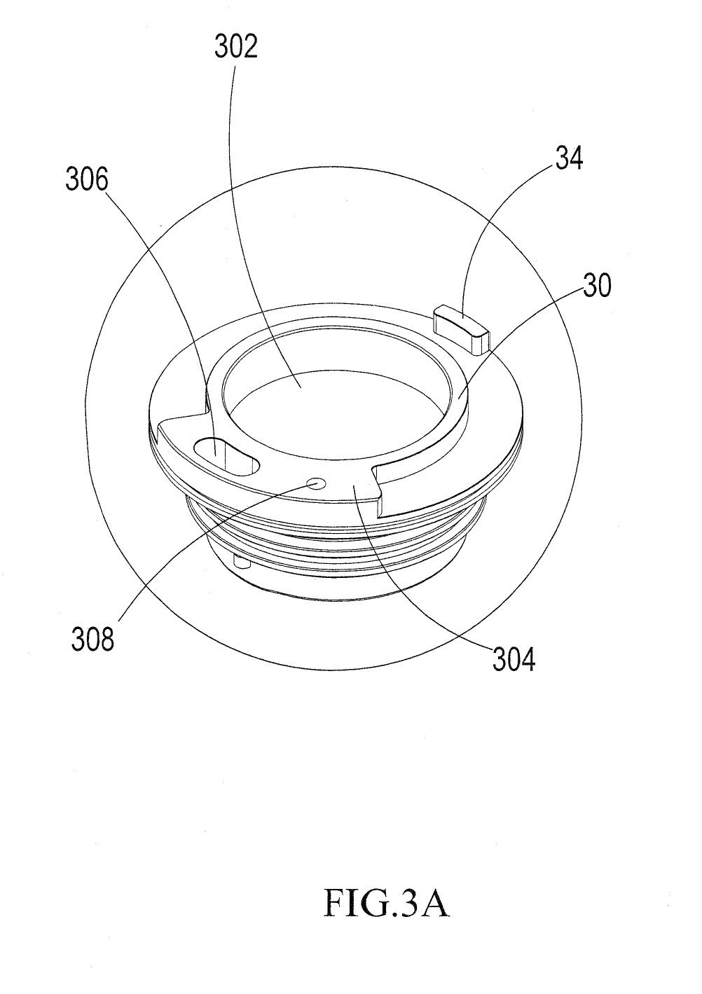

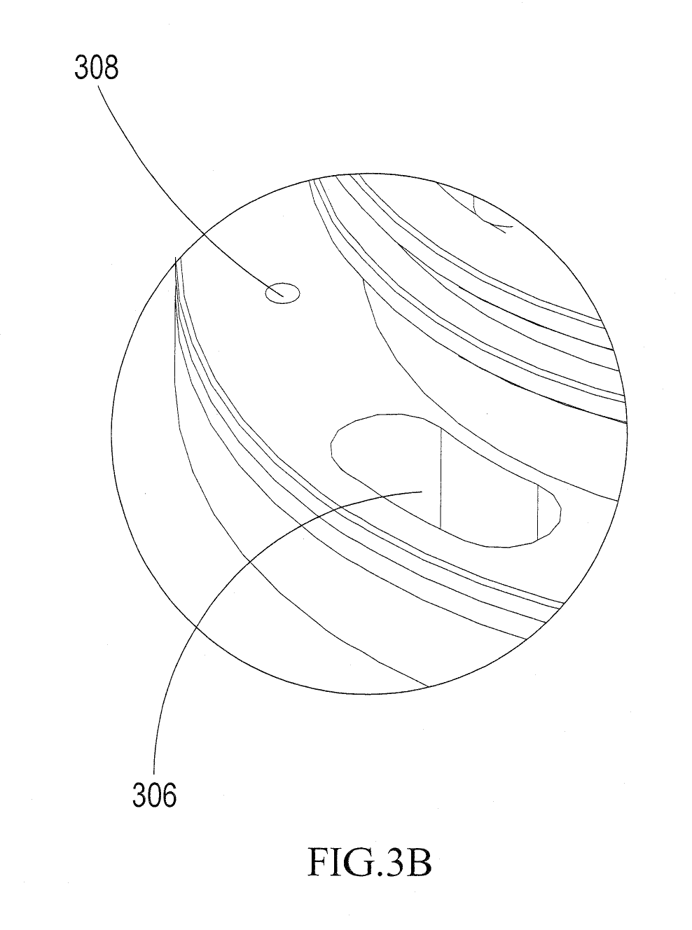

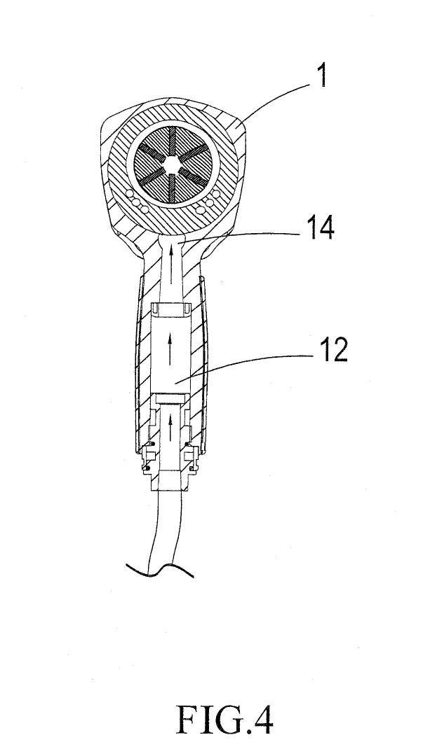

FIGS. 2, 3, 3A and 3B are cross-sectional and three-dimensional exploded views in accordance with an embodiment of the present invention. Referring to FIGS. 2, 3, 3A and 3B, a structure for adjusting positive or reverse rotation of a pneumatic tool contains an outer casing 1 formed with an air incoming chamber 12 and a reducing air intake 14 (as shown in FIG. 4) communicating with the air incoming chamber 12, a driving device 2, that is, a fan motor arranged in the outer casing 1, wherein a bearing seat 20 is arranged in the driving device 2, and a cover 22 is arranged at a side surface of the driving device 2 and provided with a positive air intake 222 and reverse air intake 224, and a knob extending with an annular wall for separating air incoming from air discharging, wherein an armature slot 302 formed at the annular wall 30 connects to and communicates with the bearing seat 20, wherein the annular wall 30 has a protrusion 304 formed with a first air intake 306, wherein the protrusion 304 butts against the cover 22, wherein the first air intake 306 communicates with the positive or reverse air intake 222 or 224, wherein the knob 3 has a rotating portion 32 for adjusting positions of the protrusion 304 from the outside of the outer casing 1. The protrusion 304 is formed with a second air intake 308 having an aperture diameter smaller than that of the first air intake 306, and thus this assembly can be used for air adjustment. The annular wall 30 apart from the protrusion 304 extends with a balance block 34 butting against the cover 22. An inner casing 16 arranged in the outer casing 1 and fitting around the driving device 2 is formed with multiple air vents 160.

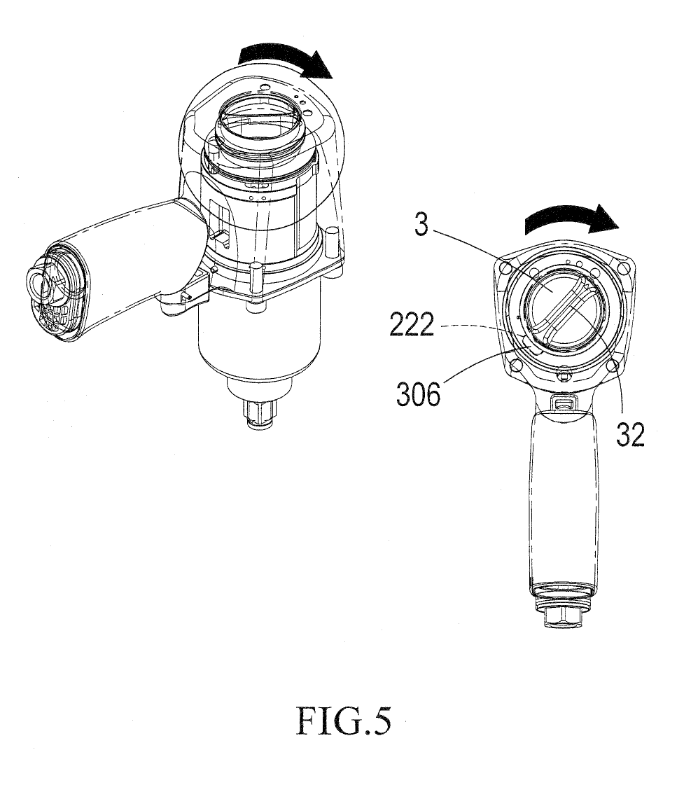

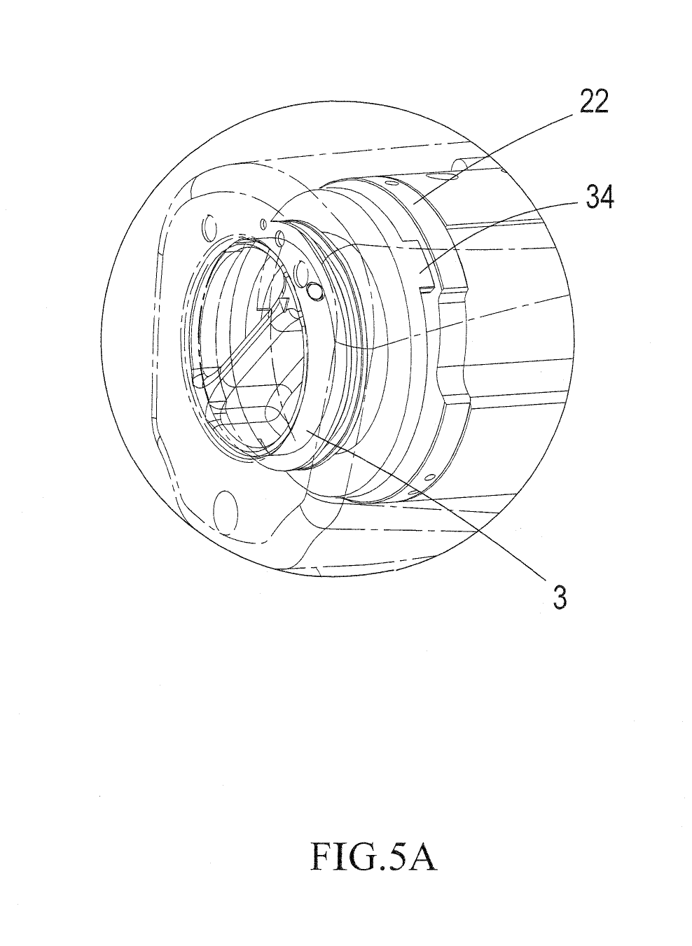

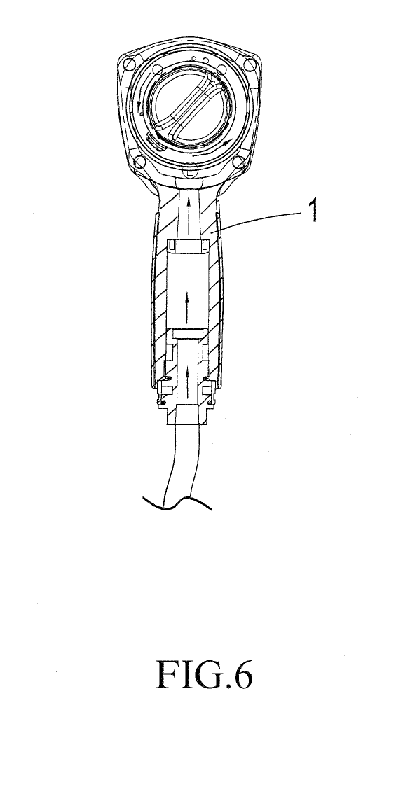

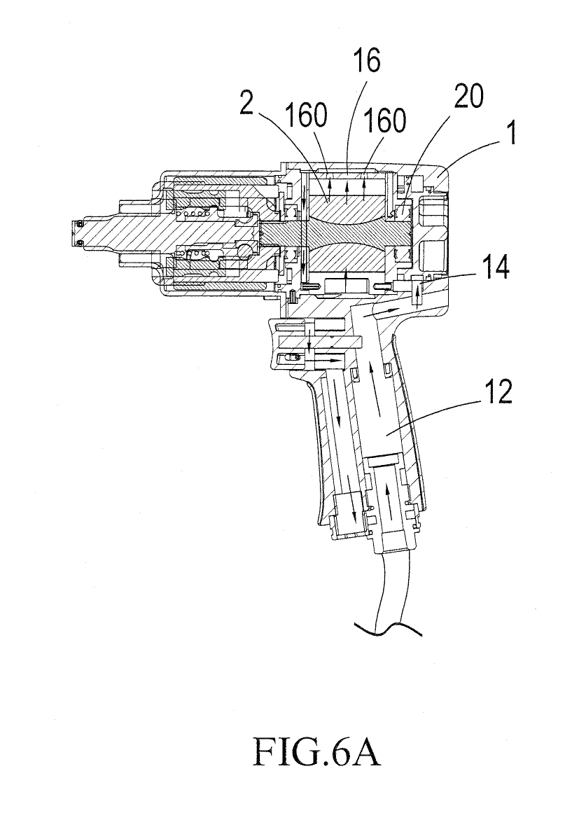

In accordance with the present invention, the operation using the above structure is illustrated as below. FIG. 4 is a schematic view of a condition of air incoming in accordance with the present invention. FIGS. 5 and 5A are schematic views of a condition of a maximum air inflow adjusted by rotation of a knob in accordance with the present invention. FIGS. 6 and 6A are different schematic views of a condition of an air flow driving a driving device in accordance with the present invention. Referring to FIGS. 4, 5, 5A, 6 and 6A, an air supply source is arranged on the casing 1 such that air can flow from the air incoming chamber 12 and through the air intake 14. The air intake 14 is reduced and has an expansion portion at a position of air discharging. Thereby, air can flow fast.

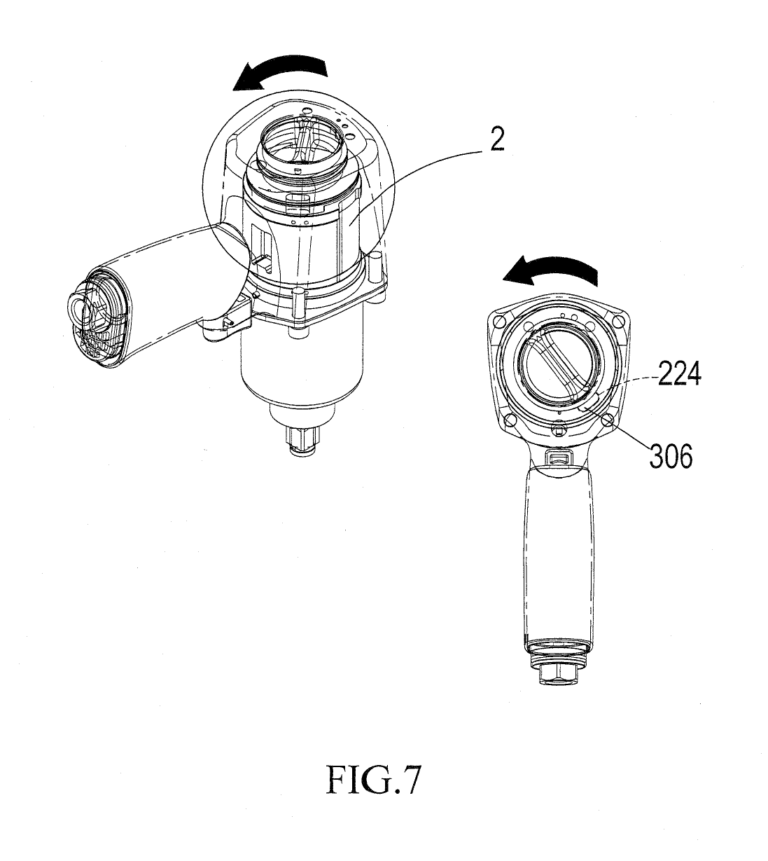

The protrusion 304 has a position, relative to the cover 22, that can be adjusted using the rotating portion 32 of the knob 3. When the knob 3 is rotated, the first air intake 306 of the protrusion 304 can be aligned with the positive air intake 222. The first air intake 306 has an aperture diameter greater than that of the second air intake 308, and thereby a maximum air outflow and a maximum power source can be created when the first air intake 306 is completely aligned with the positive air intake 222. Air can be income from the positive air intake 222 such that the pneumatic tool operates in positive rotation driven by the driving device 2. In the contrary, referring to FIG. 7 that is a schematic view of a condition of a pneumatic device operating in reverse rotation in accordance with the present invention, the reverse air intake 224 is arranged typically to have the driving device 2 to operate in reverse rotation. When the first air intake 306 is aligned with the reverse air intake 224, air income from the first air intake 306 can flow through the reverse air intake 224 and can be led to drive the driving device 2 and the pneumatic tool to operate in reverse rotation.

Referring to FIGS. 5, 5A, 3, 3A and 3B, the balance block 34 abutting against the cover 22 and extending at the annular wall 30 apart from the protrusion 304 can lead the knob 3 to rotate smoothly.

Referring to FIGS. 6 and 6A, the inner casing 16 arranged in the outer casing 1 and fitting around the driving device 2 is formed with the air vents 160 such that the driving device 2, that is a fan motor, has fans that can be driven by air discharged from the air vents 160. Thereby, the fan motor can operate in rotation. Accordingly, when air cycles in the above way, the fan motor can be effectively driven and thus the pneumatic tool can be driven.

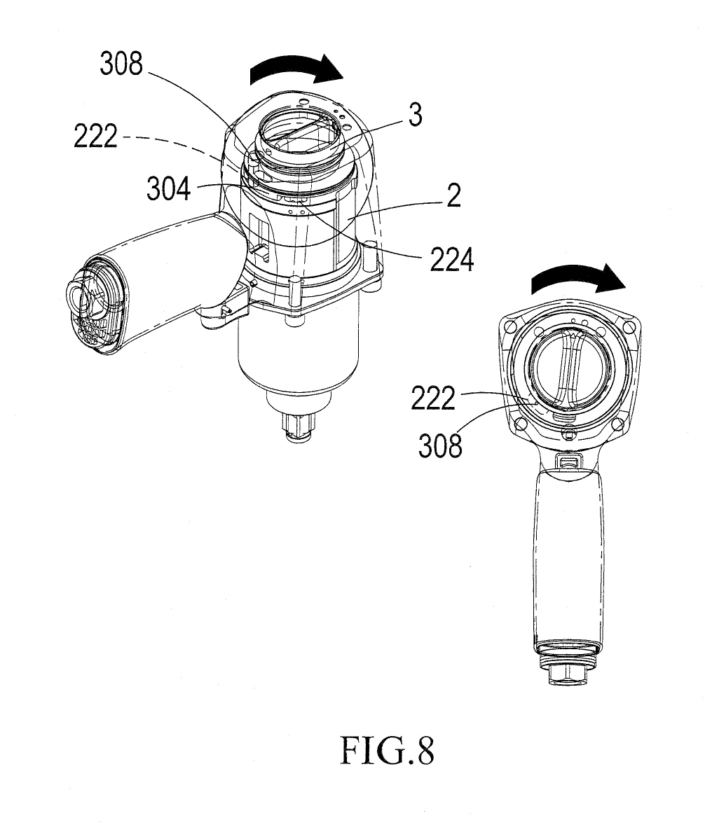

FIG. 8 is a schematic view of a condition of reducing an air outflow in accordance with the present invention. Referring to FIG. 8, the protrusion 304 of the knob 3 is formed not only with the above first air intake 306 for providing the maximum air outflow as shown in FIG. 5 but with the second air intake 308 having an aperture diameter smaller than that of the first air intake 306. This is caused to limit air flux, and thus air flux into the driving device 2 can be reduced. Thereby, the driving device 2 is driven by a reduced force and thus the pneumatic tool operates in a reduced rotation speed. Accordingly, rotation directions and rotation speeds can be controlled using the knob 3 in combination with the positive and reverse air intakes 222 and 224 in the cover 22.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A structure for adjusting positive or reverse rotation of a pneumatic tool, comprising:
an outer casing formed with an air incoming chamber and a reducing air intake communicating with the air incoming chamber;
a driving device arranged in the outer casing, wherein a bearing seat is arranged in the driving device, wherein a cover is arranged at a side surface of the driving device and provided with a positive air intake and reverse air intake; and
a knob extending with an annular wall for separating air incoming from air discharging, wherein an armature slot formed at the annular wall connects to and communicates with the bearing seat, wherein the annular wall has a protrusion formed with a first air intake, wherein the protrusion butts against the cover, and the first air intake communicates with the positive or reverse air intake.

2. The structure of claim 1, wherein the protrusion is formed with a second air intake having an aperture diameter smaller than that of the first air intake.

3. The structure of claim 1, wherein the knob has a rotating portion for adjusting positions of the protrusion from the outside of the outer casing.

4. The structure of claim 1, wherein the annular wall apart from the protrusion extends with a balance block butting against the cover.

5. The structure of claim 1, wherein the driving device comprises a fan motor.
